(19) United States
(12) Patent Application Publication
(10) Pub. No.: US 2016/0117422 A1
(43) Pub. Date: Apr. 28, 2016

(54) REGION-BASED SYNTHESIS OF LOGIC CIRCUITS

(71) Applicant: International Business Machines Corporation, Armonk, NY (US)

(72) Inventors: George Antony, Kerala (IN); Rina Kipnis, Kiryat Motzkin (IL); Oren Lev, Yokneam Elite (IL); Vadim Liberchuk, Carmiel (IL); Sridhar H. Rangarajan, Bangalore (IN); Vinay K. Singh, Gorakhpur (IN)

(21) Appl. No.: 14/862,567

(22) Filed: Sep. 23, 2015

Related U.S. Application Data
(63) Continuation of application No. 14/525,598, filed on Oct. 28, 2014.

(51) Int. Cl. G06F 17/50

(52) U.S. Cl. CPC G06F 17/505

(57) ABSTRACT

Techniques for synthesized circuit design are described herein. The techniques include identifying a region of a synthesized logical circuit design, and un-mapping gates of the identified region. A logical resynthesis is performed on the unmapped gates based on a predetermined optimization for the identified region.

### CROSS-REFERENCE TO RELATED APPLICATION

This application is a continuation of U.S. patent application Ser. No. 14/525,598, filed on Oct. 28, 2014, which is hereby incorporated by reference.

### BACKGROUND

The present invention relates to synthesized circuit design. More specifically, the present invention relates to methods and computer program products for large block region-based synthesis for high performance microprocessor designs.

Integrated circuit devices, commonly known as chips, continue to become more powerful and complex as semiconductor manufacturing technologies have advanced. Whereas early integrated circuit devices included fewer than one hundred transistors, it is now common to integrate hundreds of millions of transistors into a single integrated circuit device. This increased transistor count enables some operations that once required several integrated circuit devices to now be implemented in a single integrated circuit device, often providing greater performance at a lower cost. For example, where previously a data processing system might require separate integrated circuit devices for a microprocessor, a memory, a bus interface, and a memory controller, advances in chip density now permit all of these functions to be integrated into the same integrated circuit device. Such devices are typically known as “systems on a chip” due to the high level of integration they provide.

Increases in chip density have also significantly affected the design methodologies used for integrated circuit chips. Rather than manually laying out individual transistors or logic gates in a design to obtain a desired logic function, typically the functional aspects of the design process are separated from the physical aspects. The functional aspects of a design are typically addressed via a process known as a logic design, which results in the generation of a functional definition of a circuit design, typically defined in a hardware description language (HDL) such as VHDL or Verilog. An HDL representation of a circuit is analogous in many respects to a software program, as the HDL representation generally defines the logic or functions to be performed by a circuit design.

In order to improve the automation of synthesized blocks in high-performance microprocessor designs, synthesis may be focused on single large, flat, high performance blocks. The high-performance nature of these designs can make physical synthesis challenging in terms of specific regions of a synthesized logic circuit experiencing characteristics such as congestion, power consumption, timing issues, and the like.

### SUMMARY

In one embodiment, a method for synthesis of logical circuits is described herein. The method may include identifying a region of a synthesized logical circuit design. The method may include un-mapping gates of the identified region, and performing a logical resynthesis on the unmapped gates based on a predetermined optimization for the identified region.

In another embodiment, a computing device including a storage device and a processor is described herein. The storage device includes instructions that when executed by the processor cause the computing device to identify a region of a synthesized logical circuit design. The instructions may cause the computing device to un-map gates of the identified region, and perform a logical resynthesis on the unmapped gates based on a predetermined optimization for the identified region.

In yet another embodiment, computer program product for synthesis of logical circuits is described herein. The computer product includes a computer readable storage medium having program code embodied therewith, the program code executable by a processor to perform a method including identifying a region of a synthesized logical circuit design, un-mapping gates of the identified region, and performing a logical resynthesis on the unmapped gates based on a predetermined optimization for the identified region.

### BRIEF DESCRIPTION OF DRAWINGS

FIG. 1 is a block diagram of a computing system configured to resynthesize a region of a synthesized logic circuit.

FIG. 2 is a block diagram illustrating a synthesized circuit having regions to be resynthesized.

FIG. 3 is a flow diagram illustrating a resynthesis of marked gates.

FIG. 4 is a flow diagram illustrating an identification of regions for resynthesis.

FIG. 5 is a block diagram illustrating a method for resynthesizing a region of a synthesized logic circuit.

FIG. 6 is a block diagram depicting an example of a tangible, non-transitory computer-readable medium that can be used to resynthesize a region of a synthesized logic circuit.

### DETAILED DESCRIPTION

The subject matter disclosed herein relates to techniques to resynthesize a region of a synthesized logic circuit. As discussed above, the high-performance nature of logic synthesis, such as in large-block synthesis (LBS) makes physical synthesis challenging in terms of regions experiencing high levels of power consumption, high levels of congestion, high levels of timing critical gates, and the like. The techniques described herein enable a synthesized logic circuit to be resynthesized in specific areas experiencing high levels of congestion, power consumption, or high levels of timing critical gates. In embodiments, the technique enables a designer to apply a different set of synthesis constraints to different regions of the logic circuit design while keeping the rest of the design implementation unchanged.

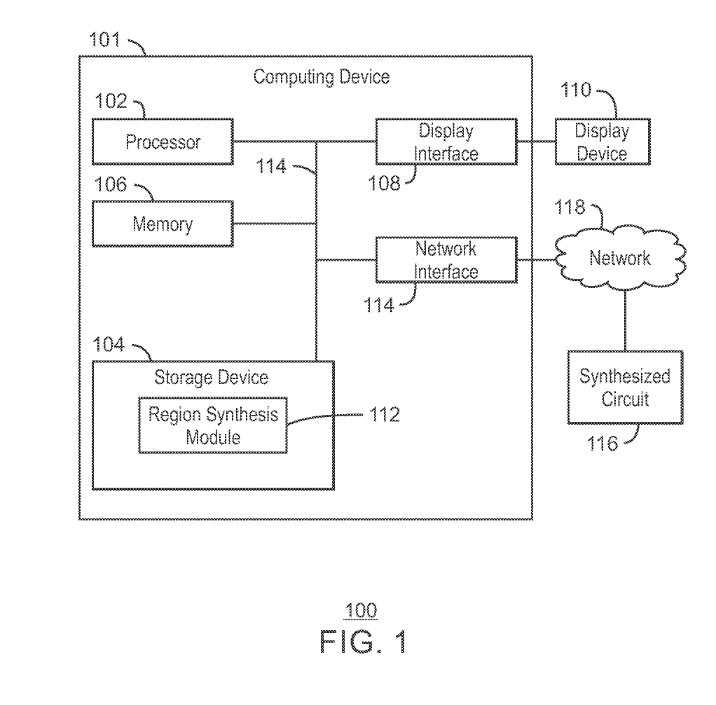

FIG. 1 is a block diagram of a computing system configured to resynthesize a region of a synthesized logic circuit. The computing system 100 may include a computing device 101 having a processor 102, a storage device 104 comprising a non-transitory computer-readable medium, a memory device 106, a display interface 108 communicatively coupled to a display device 110. The storage device 104 may include a region synthesis module 112 configured to resynthesize a region of a synthesized circuit 116. In some cases, the computing device 101 may include a network interface 114 configured to enable the synthesized circuit 116 to be resynthesized a network 118.

The region synthesis module 112 may be logic, at least partially comprising hardware logic. In embodiments, the region synthesis module 112 may be implemented as instructions executable by a processing device, such as the processor 102. The instructions may direct the processor to identify a region of a synthesized logical circuit design, and un-map gates of the identified region. The region synthesis module 113 may perform a logical resynthesis on the unmapped gates based on a predetermined optimization for the identified region.

The processor 102 of the computing device 101 of FIG. 1 may be a main processor that is adapted to execute the stored instructions. The processor 102 may be a single core processor, a multi-core processor, a computing cluster, or any number of other configurations. The memory unit 106 can include random access memory, read only memory, flash memory, or any other suitable memory systems. The main processor 102 may be connected through a system bus 114 to components including the memory 106, the storage device 104, and the display interface 108.

The block diagram of FIG. 1 is not intended to indicate that the computing device 101 is to include all of the components shown in FIG. 1. Further, the computing device 101 may include any number of additional components not shown in FIG. 1, depending on the details of the specific implementation.

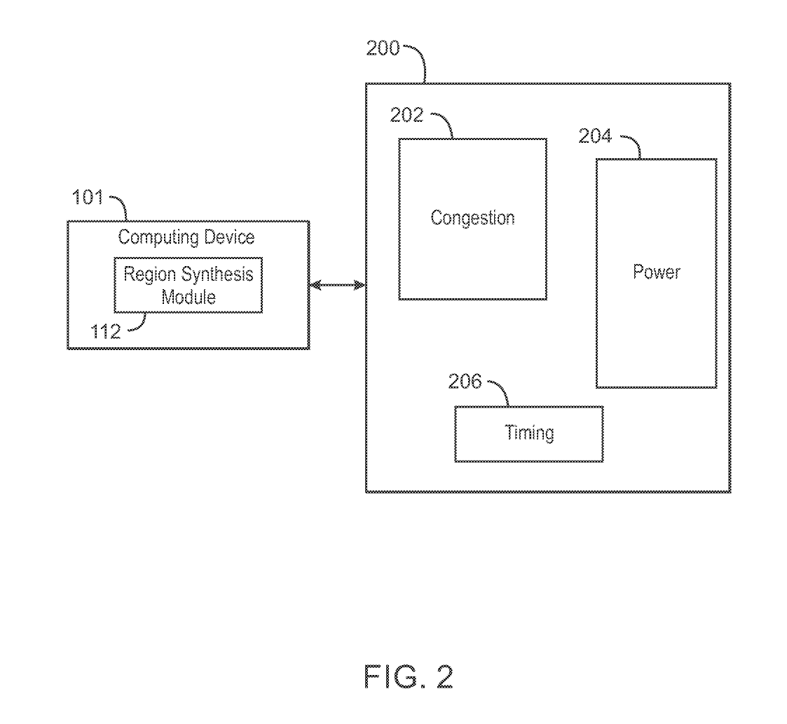

FIG. 2 is a block diagram illustrating a synthesized circuit having regions to be resynthesized. A synthesized circuit 200 may have been previously synthesized by techniques associated with large block synthesis (LBS) wherein the same set of synthesis constraints are applied to an entire design of the synthesized circuit 200.

In some cases, when the same set of synthesis constraints are applied to the entire design, the synthesized circuit 200 may exhibit regions having certain challenges. As illustrated in FIG. 2, the synthesized circuit 200 may include one or more challenged regions, such as regions 202, 204, 206. For example, the region 202 may be associated with high levels of congestion, the region 204 may be associated with high levels of power consumption, and the region 206 may be associated with high levels of timing critical gates.

As illustrated in FIG. 2, the computing device 101 including the region synthesis module 112, may be used to resynthesized one or more of the regions 202, 204, 206 in order to optimize a given region. The optimization performed by the region synthesis module 112 may be based on a given set of constraints focused on the type of challenge associated with any of the given regions 202, 204, or 206. The region synthesis module 112 may un-map gates of the identified region, and perform a logical resynthesis on the unmapped gates based on a predetermined optimization for any of the regions 202, 204 206.

As discussed in more detail below, an identified region, such as one of the regions 202, 204, and 206, may include gates. The region synthesis module 112 may mark the gates of an identified region. Further, neighboring gates may also be marked. Unmarked gates may then be frozen to protect the unmarked gates from resynthesis by the region synthesis module 112.

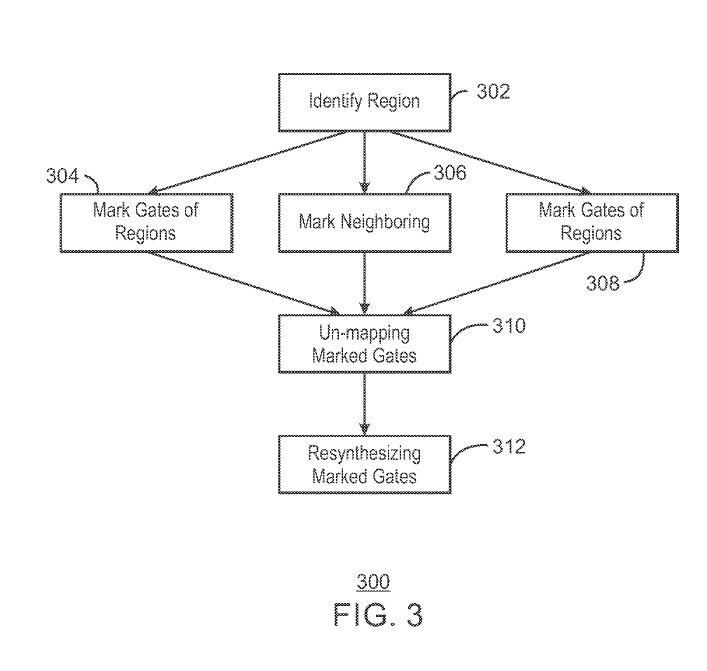

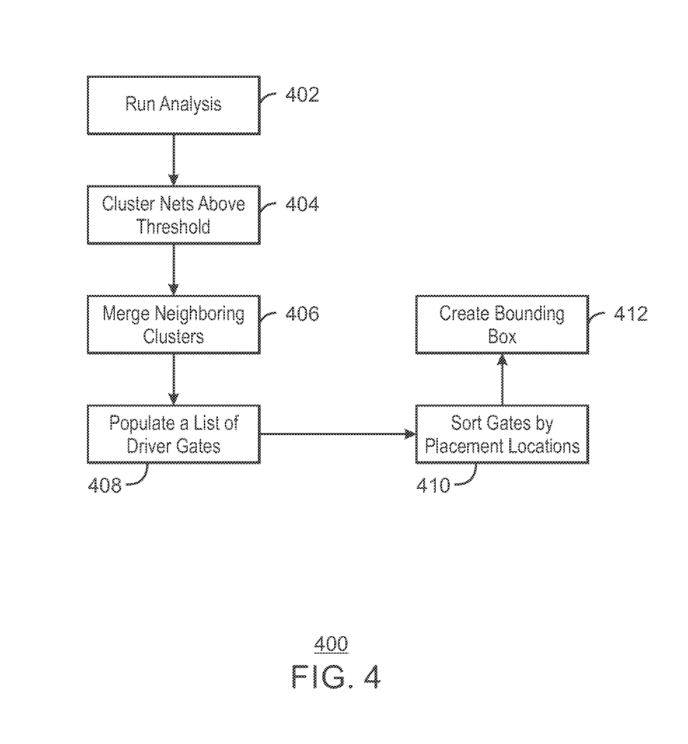

FIG. 3 is a flow diagram illustrating a resynthesis of marked gates. At 302 a region may be identified. As discussed in more detail below in regard to FIG. 4, a region may be identified by an automated tool. In some cases, a region may be identified by analysis of a circuit designer. In any case, at 304 gates of the identified region are marked, and at 306, neighboring gates are marked. Neighboring gates may include gates that directly drive gates of the region identified at block 302.

As discussed above in regard to FIG. 2, unmarked gates are frozen at block 308. Freezing unmarked gates at block 308 may include fixing locations of the unmarked gates during any resynthesis performed upon the identified region. At block 310, the marked gates are un-mapped, and, at block 312, the un-mapped gates are resynthesized.

Resynthesizing the un-mapped gates at block 312 includes applying a set of constraints that are specific to the challenge associated with the identified region. For example, for a timing challenged region, resynthesizing 312 may include applying a logical synthesis optimizing timing for the challenged region with a known tradeoff of power consumption, area of the region, and the like. In a congestion challenged region, resynthesizing 312 may include a relatively aggressive layer promotion in comparison to a layer promotion existing in the previous synthesis of the congestion challenged region. Layer promotion may include limiting a number of nets that can be routed on higher planes of the synthesized logical circuit that may lead to congestion issues in the region.

In some examples, the resynthesizing performed at block 312 may include unfreezing a fan-in cone and a fan-out cone of the marked gates, and optimizing the fan-in and fan-out cones by performing one or more of gate sizing, voltage threshold optimization, buffer optimization, layer-tuning, and the like. Gate sizing may refer to a timing optimization in which full logic paths may be analyzed to find an optimized channel width of transistors for each gate of the identified region along each full path to achieve an improved timing on each full path. Buffer optimization may include building a buffer tree having improved timing, to avoid electrical fails, or to optimize power consumption for the identified region. Layer tuning may include assigning different nets to different routing plans to avoid congestion and optimize timing wherein higher planes of the identified region are faster than lower planes due to relatively more low-pass resistor-capacitor circuits in the higher planes that are less available in the lower planes.

FIG. 4 is a flow diagram illustrating an identification of regions for resynthesis. The techniques described herein include identifying a region associated with a given challenge as discussed above in regard to FIG. 2 and FIG. 3. In one embodiment, a user of the techniques described herein may automatically identify the top n regions having a given challenge, such as congestion.

At block 402, a congestion analysis is run, and at block 404, clustering of nets above a certain threshold may be performed. In one scenario, the threshold may be a percentage of congestion associated with the nets. For example, clustering of nets having 85% congestion may be performed at block 404. At block 406, neighboring clusters are merged, and a list of driver gates is populated at block 408. The list of driver gates populated at block 408 is associated with the clustered nets of block 404.

At block 410, gates in the list are sorted by placement locations, and at block 412, a bounding box is created. For example, a bounding box created at block 412 may include placement coordinates of the first and the last elements of the list sorted at block 410.

The techniques for identifying a region may be used. For example, the identified region may be based on a bounding box as discussed above. In other scenarios, the identified region may be identified based on a logic hierarchy, a logic cone, a logic path, or any combination thereof.

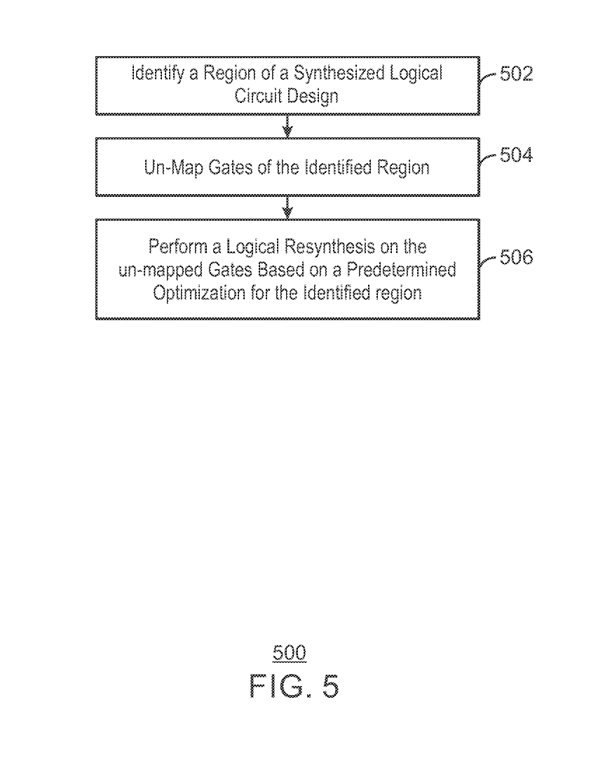

FIG. 5 is a block diagram illustrating a method for resynthesizing a region of a synthesized logic circuit. At block 502, a region of a synthesized logical circuit may be identified. As discussed above in regard to FIGS. 2-4, the identified region may be associated with a particular challenge, such as congestion, power consumption, timing critical gates, when compared to other portions of the synthesized logical circuit.

At block 504, gates of the identified region are un-mapped. Un-mapping may refer to transforming a physical circuit implementation back to a Boolean function associated with pre-logic synthesis. At block 506, a logical resynthesis is performed on the un-mapped gates based on a predetermined optimization for the identified region. The predetermined optimization may be based on the particular challenge associated with the identified region. For example, the optimization may include reducing congestion of the identified region, reducing power consumption of the identified region, reducing timing-critical gates of the identified region, among other types of optimizations for the identified region.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

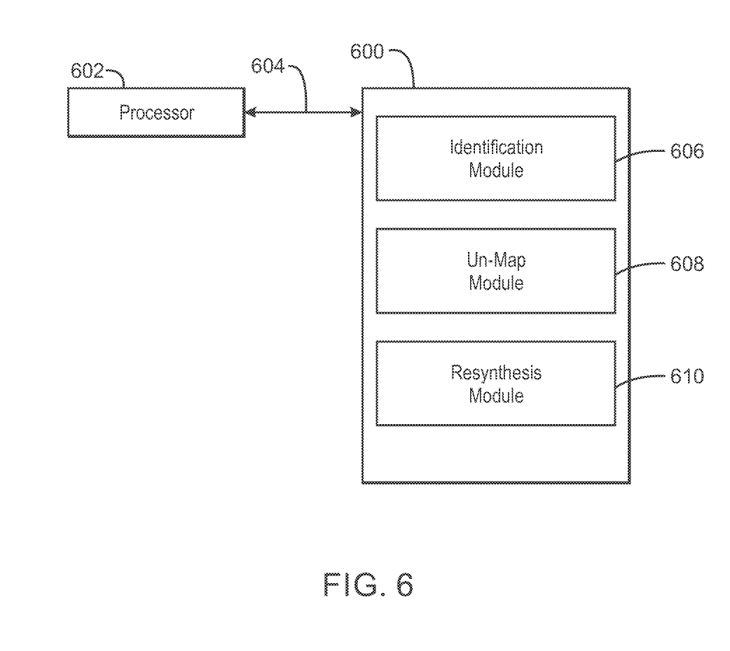

FIG. 6 is a block diagram depicting an example of a tangible, non-transitory computer-readable medium that can be used to resynthesize a region of a synthesized logic circuit. The tangible, non-transitory, computer-readable medium 600 may be accessed by a processor 602 over a computer bus 604. Furthermore, the tangible, non-transitory, computer-readable medium 600 may include computer-executable instructions to direct the processor 602 to perform the steps of the current method.

The various software components discussed herein may be stored on the tangible, non-transitory, computer-readable medium 600, as indicated in FIG. 6. For example, an identification module 606 may identify a region of a synthesized logical circuit design. An un-map module 608 may be configured to un-map gates of the identified region. A resynthesis module 610 may be configured to perform a logical resynthesis on the unmapped gates based on a predetermined optimization for the identified region.

The computer-readable medium 600 may be configured with additional modules, or the modules 606, 608, 610 may be configured to perform additional procedures as discussed above in regard to FIGS. 1-5 above.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for synthesis of logical circuits, comprising:
identifying a region of a synthesized logical circuit design;
un-mapping gates of the identified region; and
performing a logical resynthesis on the unmapped gates based on a predetermined optimization for the identified region.

2. The method of claim 1, further comprising:
marking gates of the identified region;
marking neighboring gates comprising gates driving the gates of the identified region; and
freezing unmarked gates outside of the identified region and the neighboring gates.

3. The method of claim 2, wherein freezing comprises:
protecting the unmarked gates from resynthesis by setting resynthesis hide flags on the unmarked gates; and
fixing locations of the unmarked gates.

4. The method of claim 2, further comprising:
placing the resynthesized unmapped gates; and
performing the predetermined optimization of the resynthesized unmapped gates based on one or more constraints associated with the predetermined optimization.

5. The method of claim 4, further comprising:
unfreezing a fan-in cone and a fan-out cone of the marked gates; and
optimizing the fan-in and fan-out cones by performing one or more of:
gate-sizing;
voltage threshold optimization;
buffer optimization; and
layer-tuning.

6. The method of claim 1, wherein identifying the region of the synthesized logical circuit design comprises:
performing an analysis on a pre-synthesized net list of the synthesized logical circuit design, wherein the analysis is related to the predetermined optimization;
forming clusters of critical nets of the net list based on an optimization threshold of the predetermined optimization.

7. The method of claim 1, wherein region is identified based on:
a physical bounding box;
a logic hierarchy;
a logic cone;
a logic paths; or
any combination thereof.

8. The method of claim 1, wherein the synthesized logical circuit design is based on a first set of synthesis constraints, and wherein the logical resynthesis performed on the unmapped gates is based on a second set of synthesis constraints different than the first.
